(19) United States
(12) Patent Application Publication
(10) Pub. No.: US 2024/0324762 A1
(43) Pub. Date: Oct. 3, 2024

(54) ORAL HYGIENE DEVICES FOR ANIMALS AND METHODS OF USING

(71) Applicant: Mindful People LLC, Los Angeles, CA (US)

(72) Inventor: Michael Toofer, Los Angeles, CA (US)

(21) Appl. No.: 18/620,588

(22) Filed: Mar. 28, 2024

Related U.S. Application Data
(60) Provisional application No. 63/455,528, filed on Mar. 29, 2023.

(51) Int. Cl. A46B 9/04; A61D 5/00

(52) U.S. Cl. CPC A46B 9/04; A61D 5/00; A46B 2200/1086

(57) ABSTRACT

Disclosed are oral hygiene devices for animals, such as cats and dogs, and methods for cleaning the teeth and gums of the animals using the devices. The devices include a proximal handle portion and a distal portion with a cleaning head with bristles, with the proximal and distal portions being detachable. One proximal portion features a curved neck, a tapered cleaning head with angled bristles, and a protuberance at the end of the cleaning head. Another proximal portion features a curved neck and a cylindrical cleaning head with clusters of bristles about its circumference arranged in a staggered pattern.

### PRIORITY CLAIM

This application claims the benefit of commonly owned U.S. Provisional Patent Application No. 63/455,528, filed Mar. 29, 2023, the disclosure of which is incorporated in its entirety herein by reference.

### FIELD OF INVENTION

The invention is directed to oral hygiene devices for cleaning the teeth or gums of animals.

### BACKGROUND

Proper oral hygiene is important for maintaining the health of oral cavity tissues, including teeth and gums. In many cases, the subject in need of oral hygiene is an animal, such as a pet, and therefore it is necessary that a caregiver provide oral hygiene to the oral cavity of the subject. In some cases, the anatomical features of an oral cavity of an animal, such as the oral cavity of a dog or cat, make it difficult to optimally clean the teeth and gums using toothbrush designs intended for human use. For example, cats have small mouths and tight lips making cleaning of their teeth very challenging. Existing toothbrush designs for humans are less than ideal for use in animals and can make it difficult for the user to efficiently and properly clean teeth and stimulate gums in an animal such as a dog or cat.

### SUMMARY

The invention provides oral hygiene devices having, in the least, unique and innovative features that facilitate better oral hygiene, such as improved methods for cleaning and/or stimulating oral tissues, such as teeth and/or gums in an animal such as a pets.

In embodiments, the invention provides a manual oral hygiene device for a pet, preferably a cat, that has a proximal (user) portion that includes a handle to be held by a user, the handle optionally being along a central axis of the proximal portion. The device also includes a distal (subject) portion, the distal portion includes bristles, the device includes one or more of the following features:
(a1) the distal portion of the device includes a cleaning head, the cleaning head includes bristles and having distal and proximal ends, the distal end of the cleaning head includes a distally-extending protuberance, optionally the protuberance configured to taper from wider to narrower as it extends distally, optionally the protuberance curved away from the cleaning head;
(a2) the distal portion of the device includes a cleaning head, the cleaning head having distal and proximal ends, and includes bristles having a bristle patten that is wider towards the proximal end as compared to the distal end of the cleaning head;
(a3) the distal portion of the device includes a cleaning head, the cleaning head having distal and proximal ends, and includes bristles that are longer towards the proximal end as compared to the distal end of the cleaning head;
(a4) the distal portion of the device includes a cleaning head, the cleaning head including bristles, wherein the bristles are arranged on the cleaning head in the form of clusters of the bristles, wherein each cluster of bristles is spaced apart from other clusters of bristles on the cleaning head; optionally wherein bristles of each cluster are arranged in a staggered pattern on the cleaning head;
(a5) the distal portion includes a cleaning head having bristles, the distal portion includes a neck portion that is proximal to the cleaning head, the neck portion extending from the distal end of the proximal portion of the device, wherein part of the neck portion is angled away from the central axis of the proximal portion of the device, optionally the neck portion having a curved configuration; and/or
(a6) the distal portion of the device being detachable from the proximal portion of the device, optionally wherein the proximal portion of the device includes a protrusion on its distal end, and the distal portion of the device includes a recession on its proximal end, wherein the protrusion and recession can mate to lock the distal and proximal portions of the device together, optionally wherein locking occurs by twisting the proximal and distal portions relative to each other when the protrusion and recession are mated.

In embodiments, the invention provides methods for cleaning the oral cavity of an animal comprising inserting the device having one or more of the features (a1)-(a6) into the oral cavity of the animal and contacting gums or teeth of the subject with the bristles of the oral hygiene device. In some embodiments, the animal is a cat. In some embodiments, the device has the referenced feature(s) of the distally-extending protuberance, such as one which tapers from wider to narrower as it extends distally, and/or angled away from the cleaning head, and/or wherein the cleaning head is wider at its proximal end as compared to its distal end, and also wherein there are clusters of longer bristles at the proximal end, and shorter bristles at the distal end (providing a three-dimensional “tapered” or “wedge-like” configuration). The method can include a step of contacting and then moving the pet's lip with the protuberance of the distal end of the device, and then contacting the pet's teeth and/or gums with the bristles of the cleaning head. The distal protuberance of the device first contacts the oral cavity of the pet and gently spreads the pet's lip from its gum, thereby creating an access in an area between the pet's lips and gums for the cleaning head with the bristles. Alternatively, or in addition, a cleaning head having a “tapered” or “wedge-like” configuration can facilitate its entry into the oral cavity of a pet (e.g., cat) and also allows it to reach the back molars with greater ease and penetrate the gumline. The inventive design provides access to the oral cavity of the pet and facilitates cleaning of the teeth and/or gums of the pet while at the same time minimizing trauma to its oral tissues.

In other embodiments, the invention provides a manual oral hygiene device for a pet, preferably a dog, that has a proximal (user) portion that includes a handle to be held by a user, the handle optionally being along a central axis of the proximal portion, and a distal (subject) portion, the distal portion including bristles, the device including one or more of the following features (b1)-(b4):
(b1) the distal portion of the device includes a cleaning head, the cleaning head having a cylindrical configuration and a circumferential surface, and bristles extending from circumferential surface, optionally the bristles arranged in a staggered pattern on the circumferential surface;
(b2) the distal portion of the device including a cleaning head, the cleaning head including bristles, wherein the bristles are arranged on the cleaning head in the form of clusters of the bristles, wherein each cluster of bristles is spaced apart from other clusters of bristles on the cleaning head; optionally wherein bristles of each cluster are arranged in a circular pattern on the cleaning head;
(b3) the distal portion including a cleaning head having bristles, the distal portion including a neck portion that is proximal to the cleaning head, the neck portion extending from the distal end of the proximal portion of the device, wherein part of the neck portion is angled away from the central axis of the proximal portion of the device, optionally the neck portion having a curved configuration; and/or
(b4) the distal portion of the device being detachable from the proximal portion of the device, optionally wherein the proximal portion of the device includes a protrusion on its distal end, and the distal portion of the device includes a recession on its proximal end, wherein the protrusion and recession can mate to lock the distal and proximal portions of the device together, optionally wherein locking occurs by twisting the proximal and distal portions relative to each other when the protrusion and recession are mated.

In embodiments, the invention provides methods for cleaning the oral cavity of an animal comprising inserting the device having one or more of the features (b1)-(b4) into the oral cavity of the animal, such as a dog, and contacting gums or teeth of the subject with the bristles of the oral hygiene device. In particular, features of the device such as the configuration of the neck portion that is angled away from the central axis of the proximal portion of the device, or that has a curved configuration; and/or the cleaning head with its cylindrical configuration and a circumferential surface, with bristles extending from circumferential surface, allows the user to clean certain teeth in a canine, such as the back upper molars, simply by rotating the oral hygiene device, such as rotating the device in a range of 90 to 180 degrees. The unique design of the oral hygiene device allows the user to wrap the cleaning head with bristles around the back molars, and also effectively penetrate the gumline. Accordingly, the method can include a step of contacting the back molars of a canine with the cleaning head, and then rotating the device, such as in a range of 90 to 180 degrees, to effect cleaning of the molars and gumline.

In another embodiment, the invention provides a system for animal oral hygiene, the system including a handle portion that represents a proximal portion of an oral hygiene device, wherein the wherein the proximal portion of the device includes a protrusion on its distal end, and the proximal portion is configured to be used with at least one distal portion that includes a cleaning head with bristles, and the proximal portion includes a recession on its proximal end, wherein the protrusion and recession can mate to lock the distal and proximal portions of the device together, optionally wherein locking occurs by twisting the proximal and distal portions relative to each other when the protrusion and recession are mated. The system can include more than one proximal portion configured to treat the oral cavities of different pets. That is, the system can have interchangeable distal portions configured for different animals, e.g., for both cats and dogs.

In another embodiment, the invention provides an oral hygiene system for use in the oral cavity of a pet, the system including a proximal portion configured as a handle, and a distal portion comprising a cleaning head with bristles. The distal portion of the system is detachable from the proximal portion, wherein the proximal portion includes a protrusion on its distal end, and the distal portion includes a recession on its proximal end, wherein the protrusion and recession can mate to lock the distal and proximal portions together, wherein locking occurs by twisting the proximal and distal portions relative to each other when the protrusion and recession are mated. The system can include at least two different distal portions, wherein the different distal portions are configured for use in different pets.

The invention also provides kits for providing oral hygiene to a subject. The kit can include a device of the disclosure and an oral treatment composition, such as toothpaste or composition that includes a medicament to soothe gums.

### BRIEF DESCRIPTION OF THE DRAWINGS

FIG. 1 is a perspective side view of an embodiment of an oral hygiene device.

FIG. 2 is a side view of an embodiment of an oral hygiene device.

FIG. 3 is a perspective view of the cleaning head of an embodiment of an oral hygiene device.

FIG. 4 is a side view of the cleaning head of an embodiment of an oral hygiene device.

FIG. 5 is a view of the cleaning head from the distal end of an embodiment of an oral hygiene device.

FIG. 6A is a perspective view of the distal end of the proximal portion of an embodiment of the oral hygiene device showing a protrusion for a locking mechanism.

FIG. 6B is a side view of the distal end of the proximal portion of another embodiment of the oral hygiene device showing a protrusion for a locking mechanism.

FIG. 7 is a perspective view of the proximal end of the distal portion of an embodiment of the oral hygiene device showing a recession for a locking mechanism.

FIG. 8 is a perspective side view of an embodiment of an oral hygiene device.

FIG. 9 is a side view of an embodiment of an oral hygiene device.

FIG. 10 is a perspective view of the cleaning head of an embodiment of an oral hygiene device.

FIG. 11 is a view from the distal end of the cleaning head an embodiment of an oral hygiene device.

FIG. 12 is an illustration of an oral cavity of a cat

FIG. 13 is an illustration of an oral cavity of a dog.

### DETAILED DESCRIPTION

The embodiments of the present invention described herein are not intended to be exhaustive or to limit the invention to the precise forms disclosed in the following detailed description. Rather, the embodiments are chosen and described so that others skilled in the art can appreciate and understand the principles and practices of the present invention.

The disclosure provides embodiments of oral hygiene devices for cleaning the oral cavities of animals. Oral hygiene devices of the disclosure are manual oral hygiene devices that are intended to be used with the hand, and are not electric, motorized, or battery-powered, wherein such electric toothbrushes are otherwise characterized by rapid automatic bristle motion produced via an electric motor. Electric toothbrushes are generally not tolerated well by pets, and cause stress to the animal and unfavorable oral hygiene outcomes.

Embodiments of the oral hygiene devices of the disclosure generally include a proximal (user) portion that includes a handle to be held by a user (e.g., pet owner) during a cleaning process. The handle can be defined as being along a central axis of the proximal portion of the device. The oral hygiene devices also include a distal (subject) portion which has bristles.

In some embodiments, the device includes one or more of the following features (A)-(F):
(A) The distal portion of the device has a cleaning head with bristles and distal and proximal ends, with the distal end of the cleaning head including a distally-extending protuberance which can facilitate cleaning of the oral cavity of an animal. In some cases, the protuberance is configured to taper from wider to narrower as it extends distally. In some cases, the protuberance is angled away from the cleaning head;
(B) The distal portion of the device includes a cleaning head having distal and proximal ends and includes bristles having a bristle patten that is wider towards the proximal end as compared to the distal end;
(C) The distal portion of the device includes a cleaning head having distal and proximal ends, and the bristles are longer towards the proximal end as compared to the distal end;
(D) The distal portion of the device includes a cleaning head including bristles arranged on the cleaning head in the form of clusters of bristles, wherein each cluster is spaced apart from other clusters on the cleaning head. Optionally the bristles of each cluster are arranged in a circular pattern on the cleaning head;
(E) The distal portion includes a cleaning head having bristles and a neck portion that is proximal to the cleaning head, the neck portion extending from the distal end of the proximal portion of the device, wherein part of the neck portion is angled away from the central axis of the proximal portion of the device. Optionally the neck portion has a curved configuration;
(F) The distal portion of the device is detachable from the proximal portion of the device. Optionally, the proximal portion of the device includes a protrusion on its distal end, and the distal portion of the device includes a recession on its proximal end, and protrusion and recession can mate to lock the distal and proximal portions of the device together. Optionally locking occurs by twisting the proximal and distal portions relative to each other when the protrusion and recession are mated.

The oral hygiene device can include any combination of features (A)-(F).

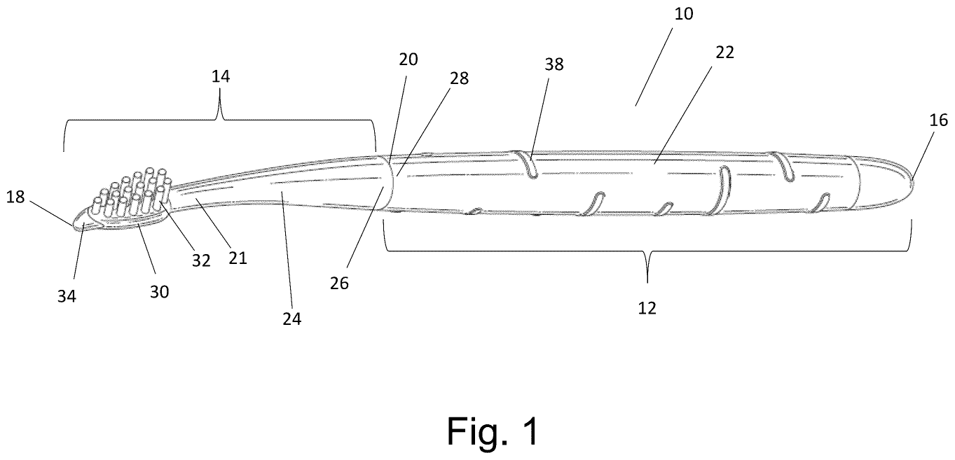

Reference is made to FIG. 1, showing an oral hygiene device 10 of the disclosure. Oral hygiene device 10 is particularly suitable for cleaning the teeth and gums of cats. The oral hygiene device 10 has a proximal portion 12, that can function as a handle of the device. The proximal portion 12 can be defined by a proximal end 16 and a distal end 28, and a length between these ends 16 and 28. In some embodiments, the length between the proximal end 16 and the distal end 28 of the proximal portion 12 is in the range of about 10 cm to about 15 cm, or about 11.5 to about 13 cm.

The proximal portion 12 representing the handle can be of any suitable configuration to be held and manipulated by a user. The outer surface of the proximal portion 12 representing the handle can have a continuously curved surface, such that when viewed in a cross section from one of the ends, has a circular, oval, or oblong shape. The outer surface may optionally have one or more flat surfaces, such as being polygonal when viewed in cross section, or may have a combination of flat and curved surfaces.

The proximal portion 12 representing the handle can have a constant diameter along the length of the device, or the diameter can vary. As shown in FIG. 1, the diameter of the handle varies along its length with the diameter being slightly greater near the mid-point (along the central axis) of the proximal portion 12 as compared to the diameter near the proximal end 16 or the distal end 28. For example, near the mid-point along the central axis of the proximal portion 12, the device can have a diameter in the range of about 1.0 cm to about 1.5 cm, or about 1.1 cm to about 1.3 cm. Near the ends (16, 28) of the proximal portion 12, the device can have a diameter in the range of about 0.8 cm to about 1.3 cm, or in the range of about 0.9 cm to about 1.1 cm. FIG. 1 shows the device having a rounded proximal end 16, but the device may have other proximal end shapes (e.g., flat, etc.).

The proximal portion 12 representing the handle can optionally have surface features that facilitate handing of the device, such as features that prevent the proximal portion 12 slipping out of, or slipping within, a user's hand or fingers. FIG. 1 shows raised features 38 present on the outer surface of the proximal portion 12 that are perpendicular to the central axis. The raised features may be made of a material that is different than the structural material of the proximal portion 12, such a polymeric material that is softer than polymeric material of the proximal portion 12. However, various other types of surface features can be used to provide the same effect, or alternatively, a material such as soft plastic or tape can be applied to the outer surface to provide improved handling of the device. In some embodiments the handle is made from a material such as an acrylonitrile butadiene styrene (ABS) polymer, polyoxymethylene (POM), polyvinyl chloride (PVC), polycarbonate, polyurethane, or polysulfone.

The raised feature(s) on the outer surface of the proximal portion 12 can be continuous around the circumference of the proximal portion 12 at any point along its length, or, as shown in FIG. 1, the raised feature(s) can extend less than the full circumference. For example, an individual raised feature can extend 20-80% of the circumference, or 30-70% of the circumference. The proximal portion 12 can include multiple raised features extending different lengths around the circumference, wherein the multiple raised features can be either aligned with each other along the length, or out of alignment. Also, raised feature(s) of the proximal portion 12 can have an exemplary width in the range of about 0.5 mm to about 5 mm, or about 1 mm to about 2.5 mm, and an exemplary height in the range of about 0.1 mm to about 2.5 mm, or about 0.25 mm to about 1.5 mm.

In embodiments, the proximal portion 12 is detachable and (re-) attachable from the distal portion 14 of the device. A detachable/(re-) attachable feature can use a common handle for attaching distal portions with cleaning heads having different designs and that provide different functionalities. In other embodiments, the oral hygiene device 10 is unitary such as formed by a single piece of material (i.e., the proximal and distal portions of the device are not detachable/(re-) attachable).

Also shown in FIG. 1, the oral hygiene device 10 of the disclosure includes a distal portion 14 (subject/pet portion). The distal portion 14 can be defined by a proximal end 26 and a distal end 18 of the distal portion 14, and a length between these ends. In some embodiments, the length between the proximal end 26 and the distal end 18 of the distal portion 14 is in the range of about 5.5 cm to about 7.5 cm, or about 6.0 cm to 7.0 cm.

The proximal end 26 of distal portion 14 can be attached to the distal end 28 of the proximal portion 12 at interface 20, in embodiments wherein the proximal and distal portions are detachable/(re-) attachable.

The distal portion 14 can have a central neck 24 that extends from proximal end 26 distally to a cleaning head 30. The distal portion 14 can taper in a distal direction, such as where the diameter of the neck becomes smaller or the cross-sectional thickness of the neck is gradually reduced in a distal direction. For example, near the proximal end 26, the distal portion 14 can have a diameter in the range of about 0.8 cm to about 1.3 cm, or about 0.9 cm to about 1.1 cm. In embodiments, the diameter of the distal end 28 of the proximal portion 12 and the proximal end 26 of the distal portion 14 are the same. In some embodiments, and as shown in FIGS. 1-4, the section 21 of the neck near the cleaning head 30 can change in shape. For example, viewed in cross section, the neck can change in shape from a circular shape or near circular shape near the proximal end to an oblong or oval shape towards the distal end. In some embodiments, the greatest dimension in section 21 of the neck is in the range of about 0.8 cm to about 1.0 cm across, and the smallest dimension in the neck is in the range of about 0.2 cm to about 0.3 cm.

The distal portion 14 can be of any suitable configuration, such as having a continuously curved surface, that when viewed in a cross section from one of the ends, has a circular, oval, or oblong shape. The outer surface may optionally have one or more flat surfaces, such as being polygonal when viewed in cross section, or may have a combination of flat and curved surfaces. In embodiments, the distal portion 12 configuration may flatten from more of a circular configuration to an oblong configuration near the cleaning head 30.

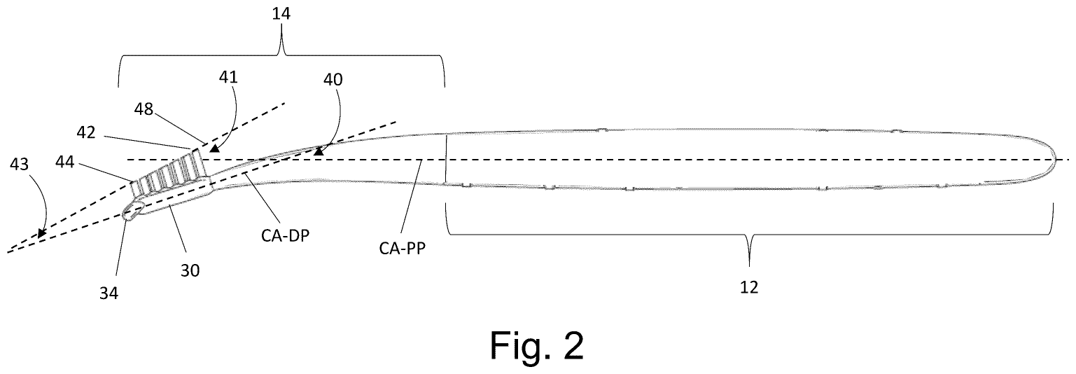

In embodiments, and as shown in FIGS. 1 and 2, the distal portion 14 can angle away from the central axis (CA-PP) of the proximal portion 12. For example, as shown in FIG. 2, the proximal portion 12 has a central axis (CA-PP), and the distal portion 14 has a central axis (CA-DP), and the angle 40 of the intersecting lines CA-PP and CA-DP is in the range of about 5° to about 40°, about 10° to about 35°, 12° to about 20°, or about 13° to about 19°.

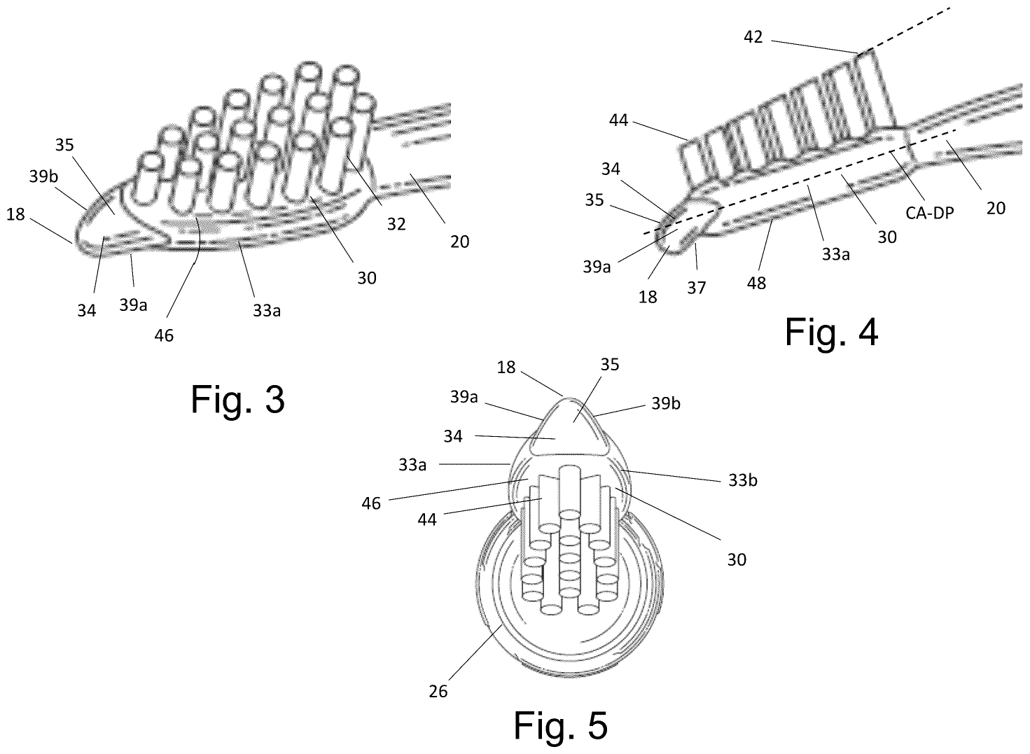

In embodiments, and with reference to FIGS. 3-5, the cleaning head 30 has flattened configuration with a first face 46 from which the clusters of bristles are attached, and then a second face 48 opposite the first face. The cleaning head 30 also has side walls (side walls 33a and 33b shown) which can have a curved surface. The cleaning head 30 can be wider towards the proximal end (i.e., closer to the neck) and narrower towards the distal end of the cleaning head 30. At its widest part, the cleaning head can be wider than the width of the neck near the cleaning head, the cleaning head having a maximum width in the range of about 0.7 cm to about 1.2 cm. At the distal portion of the cleaning head, the width of the cleaning head at its narrowest part can be in the range of 50-90% of the width of the cleaning head at its widest part. The thickness of the cleaning head 30 (i.e., between the first face 46 and second face 48) is in the range of about 0.20 cm to about 0.5 cm, or about 0.25 cm to about 0.45 cm. Accordingly, since the cleaning head 30 can be wider at its proximal end (near section 21 of the neck), this means that the cleaning head 30 can accommodate a greater number of bristle clusters across its width at is proximal end as compared to its distal end. For example, as shown in FIGS. 1, 3, and 5, there are three bristles clusters across the width of the cleaning head 30 in its central and proximal sections, wherein near the distal end of the cleaning head (where it narrows) there are one or two bristle clusters across its width.

The cleaning head 30 and neck 24 can be made from a synthetic material such as polypropylene (PP), polyurethane (PU), polyvinyl chloride (PVC), polyester (PE), polycarbonate (PC), or polyamide (PA), or from a natural material such as wood, and in particular, water-resistant woods such as bamboo, teak, acacia, cedar, redwood, cypress, and black locust, among others. In some embodiments, the material used to make the head 30 and neck 24 is different from the material used to make the handle 12.

Referring to FIGS. 1-5, the device includes a cleaning head 30 with a plurality of bristles. In embodiments, the bristles are present in a cluster 32 of bristles. In embodiments there are at least about 8 clusters of bristles, and not more than about 35 clusters of bristles, for example, a number of clusters in the range of 10-30, or 12-25. For example, each cluster of bristles can be spaced apart from other clusters of bristles on the cleaning head 30. In some embodiments, each cluster is spaced out from an adjacent cluster by about at least about 25% or at least about 50% of the width of the cluster, and up to about 200% or 250% of width of the cluster. The bristles of each cluster can be arranged in a circular shape on the cleaning head, although other cluster shapes are contemplated such as oval or polygonal. The width of each cluster can be in the range of 0.1 mm to about 0.3 mm, or about 0.15 mm to about 0.25 mm.

Each cluster of bristles can include a plurality of bristles packed adjacent to one another, with each bristle being a fraction of a millimeter in diameter. The bristles are generally made from polymeric threads. Referring to FIG. 3, the bristles can be attached to the base of the cleaning head 30 within recessions (e.g., circular in shape) made in the first face 46 of the cleaning head 30 using an adhesive.

In embodiments, referring to FIGS. 2 and 4, clusters of longer bristles 42 at the proximal end of the cleaning head 30 and shorter bristles 44 at the distal end. As shown in the FIGS. 2 and 4, the bristles of the clusters can progressively get shorter towards the distal end of the cleaning head 30. The longest bristles are up to about 1.5 cm, or up to about 1.2 cm, such in the range of 0.7 cm to 1.5 cm, or 0.8 cm to 1.2 cm, and the shortest bristles are down to about 0.3 cm, or about 0.4 cm, such as in the range of 0.3 cm to 0.7 cm, or 0.4 cm to 0.6 cm. The length of the bristles can optionally be described in relation to one another with the shortest bristles having a length in the range of 35-70%, or 40-60% of the length of the longest bristles. In some embodiments, and with reference to FIG. 2, the bristle profile can be described with reference to line 48 which corresponds to a plane at the tops of the bristles of the cleaning head 30, wherein line 48 is at an angle 41 to the central axis of the distal portion (CA-DP) and at an angle 43 to the central axis of the proximal portion (CA-PP). Angle 41 can be greater than angle 40 and/or angle 43. In some embodiments, angle 41 of the intersecting line CA-PP and line 48 is in the range of about 15° to about 45°, about 20° to about 40°, about 23º to about 36°, or about 25° to about 33°. In some embodiments, angle 41 of the intersecting line CA-DP and line 48 is in the range of about 2° to about 15°, about 4° to about 13°, about 5° to about 11°, or about 6° to about 10°. The angle 40 of the axes (CD-DP and CA-PP) of the distal and proximal portions of the device can also be described. In some embodiments, angle 40 of the intersecting line CA-DP and line CA-PP is in the range of about 5° to about 30°, about 7° to about 25°, about 10° to about 22°, or about 13° to about 19°.

Therefore, cleaning head 30 can have a three-dimensional “tapered” or “wedge-like” configuration in embodiments wherein the cleaning head is wider at its proximal end as compared to its distal end, and also wherein there are clusters of longer bristles at the proximal end, and shorter bristles at the distal end. In use, a cleaning head having a “tapered” or “wedge-like” configuration can facilitate its entry into the oral cavity of a pet (e.g., cat) and also allows it to reach the back molars with greater ease and penetrate the gumline.

Referring to FIGS. 1-5, the distal end of the cleaning head 30 includes a distally-extending protuberance 34. The protuberance 34 may alternatively be referred to as a “lip”, a “protrusion”, or a “projection”. The protuberance 34 is generally in the form of a shape-defined mass of material, such as plastic material, that is attached to the distal end of the cleaning head 30, or otherwise formed as a distal extension of the cleaning head, for example, such as by molding the two portions. The protuberance 34 can be made as the same of different material than the cleaning head 30, such as made of a synthetic material such as poly(propylene) (PP) or acrylonitrile butadiene styrene (ABS), or can be made from a natural material like wood. The protuberance 34 can be configured to taper from wider to narrower as it extends distally. For example, as shown in FIGS. 3-5, the protuberance 34 can have a top surface 35, a bottom surface 37, a first curved side 39a, and a second curved side 39b. The first curved side 39a can extend from the distal end of the curved side wall 33a of the cleaning head 30, and the second curved side 39b can extend from the distal end of the curved side wall 33b of the cleaning head 30. The first curved side 39a can meet the second curved side 39b at the distal end of the device 18 and forming a rounded tip, and providing protuberance 34 with a tapered configuration. For example, when viewed from the top or the bottom, the top surface 35 or the bottom surface 37, respectively, can have a triangular shape, or the protuberance 34 can have a tongue-like shape that extends from the curved side wall 32 surface of the cleaning head. Also, the protuberance 34 can be angled away, or curve away, from the cleaning head. For example, the protuberance 34 can project outwards distally and downwards, away from the upward direction of the bristles.

As a generally matter, the protuberance 34 does not have bristles projecting from any of its surfaces, as it is intended to function to move the lip away from the gum in the oral cavity of the pet. The curved smooth surfaces of the protuberance 34 provide gentle initial tissue contact with the lips and gums of the pet. The thickness of the protuberance 34 is generally not greater than the thickness of the cleaning head 30, and in embodiments less than the thickness of the cleaning head 30. For example, the thickness of the protuberance 34 (i.e., between the top surface 35 and bottom surface 37) is in the range of about 0.10 cm to about 0.45 cm, or about 0.15 cm to about 0.40 cm.

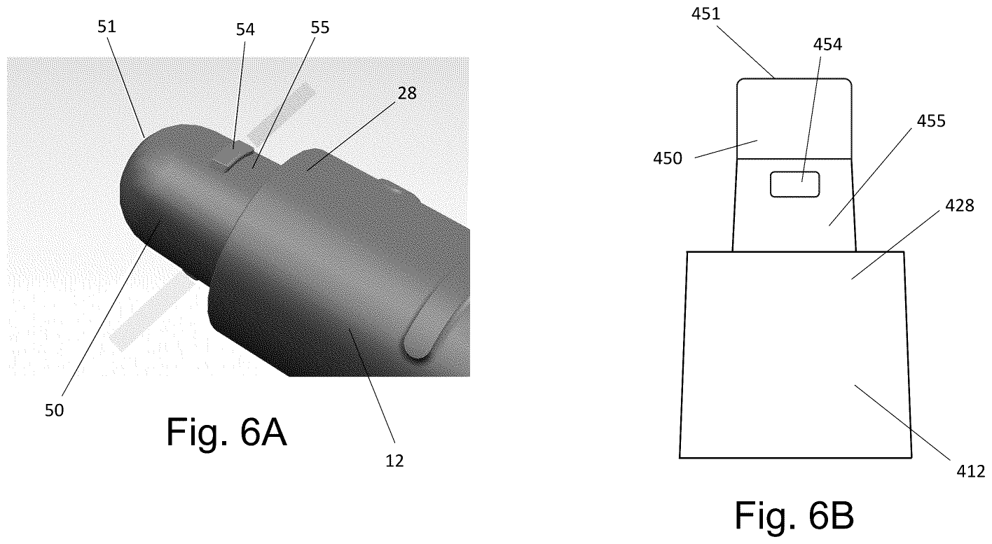

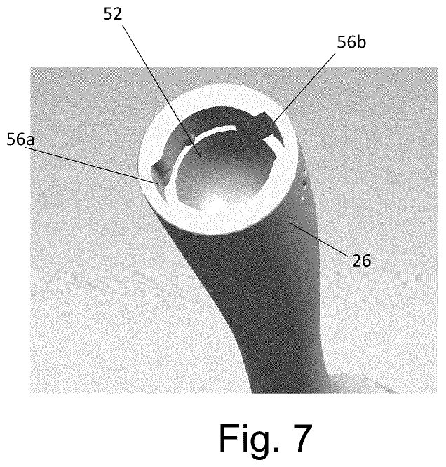

Embodiments of the invention provide an oral hygiene device where the proximal portion is detachable from and (re-) attachable to the distal portion of the device. FIG. 6A shows the distal end 28 of the proximal portion 12 of the device, which is detached from the distal portion 14 of the device. The distal end 28 includes a protrusion 50, which is shown in FIG. 6A having a rounded distal end 51, but the protrusion can be of any suitable shape that will mate into a recession 52 as shown in FIG. 7 which is within the proximal end 26 of the distal portion 14 of the device. For example, instead of a rounded end, and as shown in FIG. 6B, protrusion 450 has a flat end 451, and instead of a rounded bottom at the bottom of the recession of the distal portion, the recession can have a flat bottom (not shown). Protrusion 50, 450, also includes a first nub 54, 454, on the lateral wall 55, 455, of the protrusion 50, 450, which is shown having a raised rectangular shape (a second nub on the opposite side of the protrusion 50, 450 is not visible in this view), but any suitable shape can be used. The first (e.g., 54, 454) and second nubs are able to slot into the reciprocally-shaped grooves (56a, 56b) in the inner wall of proximal end 26 of the distal portion 14 which is formed by the recession 52. The proximal portion 12 can be locked together in place with the distal portion 14 of the device by twisting the proximal and distal portions relative to each other.

If the distal and proximal portions are detachable/(re-) attachable a common handle for attaching distal portions that provide different functionalities (e.g., having different cleaning heads) can be used.

In other embodiments, the invention provides an oral hygiene device that has a proximal (user) portion that includes a handle to be held by a user, the handle optionally being along a central axis of the proximal portion, and a distal (subject) portion, the distal portion including bristles, the device including one or more of the following features (A)-(D):
(A) The distal portion of the device having a cleaning head that has a cylindrical configuration and a circumferential surface, and bristles extending from circumferential surface. Optionally the bristles are arranged in a staggered pattern on the circumferential surface.
(B) The distal portion of the device has a cleaning head which includes bristles arranged on the cleaning head in the form of clusters of the bristles, wherein each cluster of bristles is spaced apart from other clusters of bristles on the cleaning head. Optionally, the bristles of each cluster are arranged in a circular pattern on the cleaning head.
(C) The distal portion has a cleaning head having bristles and includes a neck portion that is proximal to the cleaning head which extends from the distal end of the proximal portion of the device, wherein part of the neck portion is angled away from the central axis of the proximal portion of the device. Optionally the neck portion has a curved configuration.
(D) The distal portion of the device is detachable from the proximal portion of the device. Optionally the proximal portion of the device includes a protrusion on its distal end, and the distal portion of the device includes a recession on its proximal end which can mate to lock the distal and proximal portions of the device together. Optionally wherein locking occurs by twisting the proximal and distal portions relative to each other when the protrusion and recession are mated.

The oral hygiene device can include any combination of features (A)-(D).

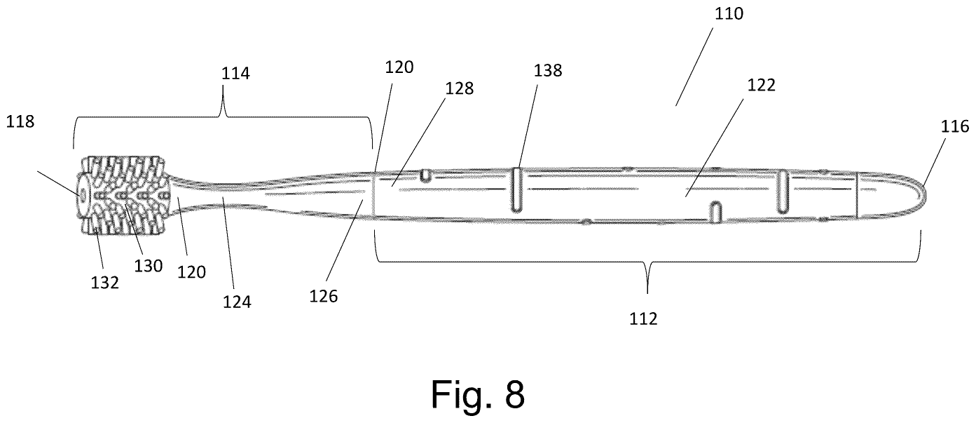

Reference is made to FIG. 8, showing another oral hygiene device 110 of the disclosure. Oral hygiene device 110 is particularly suitable for cleaning the teeth and gums of dogs. The oral hygiene device 110 has a proximal portion 112, that can function as a handle of the device, wherein the proximal portion 112 and features thereof correspond to the proximal portion 12 and features thereof of the device shown in FIG. 1. Features 116, 120, 122, 128, and 138 in FIG. 8 correspond to features 16, 20, 22, 28, and 38 of FIG. 1 and will not be described further.

Also shown in FIG. 8, the oral hygiene device 110 of the disclosure includes a distal portion 114. The distal portion 114 can be defined by proximal end 126 and distal end 118, and a length between these ends. In some embodiments, the length between the proximal end 126 and the distal end 118 of the distal portion 114 is in the range of about 5.5 cm to about 7.5 cm, or about 6.0 cm to 7.0 cm.

The distal portion 114 can be made of synthetic or natural materials as described with reference to the cleaning head 30 and neck 24 of device 10.

The proximal end 126 of distal portion 114 can be attached to the distal end 128 of the proximal portion 112 at interface 120, in embodiments wherein the proximal and distal portions are detachable/(re-) attachable.

The distal portion 114 can extend distally to a cleaning head 130. In the distal portion 114 the proximal end 126 can taper distally to a narrower central section 124 (“neck”; wherein the diameter is reduced or the cross-section thickness is reduced) which then widens again distally to a section 120 near the cleaning head 130. For example, near the proximal end 126, the distal portion 114 can have an diameter in the range of about 0.8 cm to about 1.3 cm, or in the range of about 0.9 cm to about 1.1 cm, the narrower central section 124 can have a diameter in the range of about 0.2 cm to 1.0 cm, or in the range of about 0.3 cm to 0.7 cm, and then the section 120 near the cleaning head 130 can have a diameter in the range of about 0.8 cm to about 1.3 cm, or in the range of about 0.9 cm to about 1.1 cm.

The distal portion 114 between the proximal end 126 and section 120 can be of any suitable configuration and can have a continuously curved surface, such that when viewed in a cross section from one of the ends, has a circular, oval, or oblong shape. The outer surface may optionally have one or more flat surfaces, such as being polygonal when viewed in cross section, or may have a combination of flat and curved surfaces.

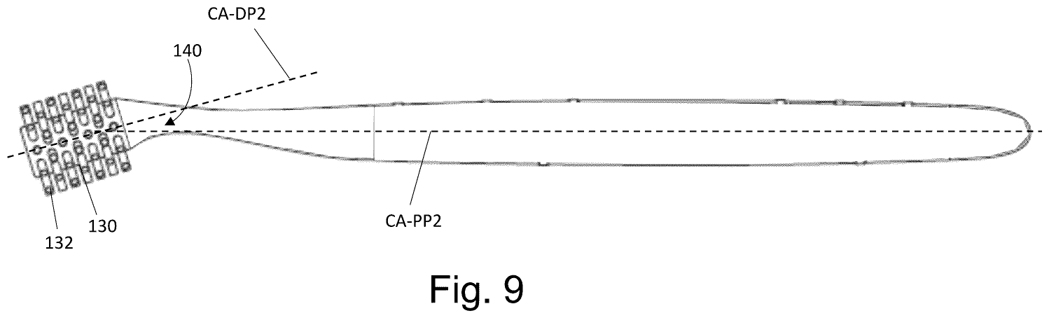

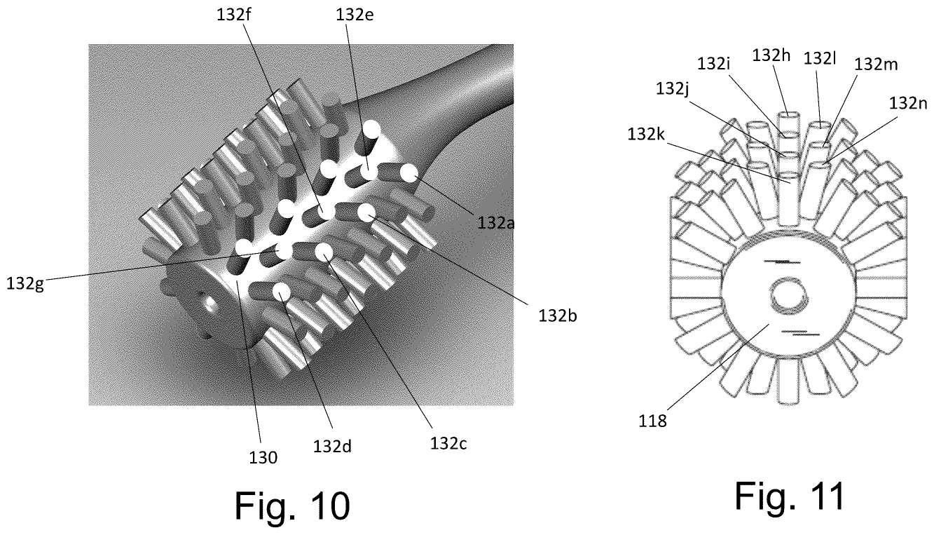

In embodiments, and as shown in FIGS. 9 and 10, the cleaning head 130 can be at an angle relative to the axis of the proximal portion 112. For example, as shown in FIG. 9, the proximal portion 112 has a central axis (CA-PP2), and the cleaning head 130 is arranged along a central axis (CA-DP2), with the angle 140 being in the range of about 5° to about 45°, about 10° to about 45°, about 10° to 20°, or about 15° to about 40°.

Referring to FIGS. 8-10, the device includes a cleaning head 130 with a plurality of bristles. The cleaning head 130 has a cylindrical configuration and a circumferential surface, and bristles 132 extending from circumferential surface. In embodiments, the cleaning head has a diameter in the range of about 0.8 cm to about 1.3 cm, or in the range of about 0.9 cm to about 1.1 cm, and a length in the range of about 1.5 cm to about 2.5 cm, or in the range of about 1.7 cm to about 2.1 cm.

In embodiments, the bristles are present in a cluster 132 of bristles. For example, each cluster of bristles can be spaced apart from other clusters of bristles on the cleaning head 130 in a staggered pattern from a proximal to distal direction. For example, with reference to FIG. 10, the cleaning head 130 has a first column of bristles (132a, 132b, 132c, and 132d) from the proximal end to the distal end of the cleaning head 130, and a second column of bristles (132e, 132f, and 132g) adjacent to the first column, the second column having one fewer bristle clusters than the first column. In exemplary arrangements, the first column has three, four, five, or six bristle clusters, and the second column as two, three, four, or five bristle clusters, respectively. Along the lengthwise axis of the cleaning head 130 the positions of the bristle clusters in the first column are spaced from the position of the bristle clusters in the second column to provide a staggered arrangement of bristle clusters. The columns of bristle clusters can be arranged around most or all of the circumferential surface of the cleaning head 130. For example, the cleaning head can include a number of columns in the range of 16-32, in the range of 18-30, or in the range of 20-28. As such, columns of bristles are formed around the circumference, but since the bristles are staggered in each column, the staggered pattern allows a greater number of bristles to be placed on the cleaning head 130. For example, there can be a number of bristle clusters in the range of 50-125, in the range of 60-110, in range of 70-105, or in the range of 75-100.

In some embodiments, each cluster of bristles is spaced out from an adjacent cluster by about at least about 25% or at least about 50% of the width of the cluster, and up to about 200% or 250% of width of the cluster. The bristles of each cluster can be arranged in a circular shape on the cleaning head, although other cluster shapes are contemplated such as oval or polygonal. The width of each cluster can be in the range of 0.1 mm to about 0.3 mm, or about 0.15 mm to about 0.25 mm.

Each cluster of bristles can include a plurality of bristles packed adjacent to one another. In embodiments, the bristle lengths are the same or approximately the same and are in the range of 0.2 cm to about 0.8 cm, or about 0.3 cm to about 0.7 cm. The bristles can be attached to the base of the cleaning head 130 within recessions (e.g., circular in shape) made in the first face of the cleaning head 130 using an adhesive.

Methods for cleaning the oral cavity of an animal which include inserting the device into the oral cavity of the animal and contacting gums or teeth of the subject with the bristles of the oral hygiene device are provided. In some embodiments, the animal is a cat or a dog.

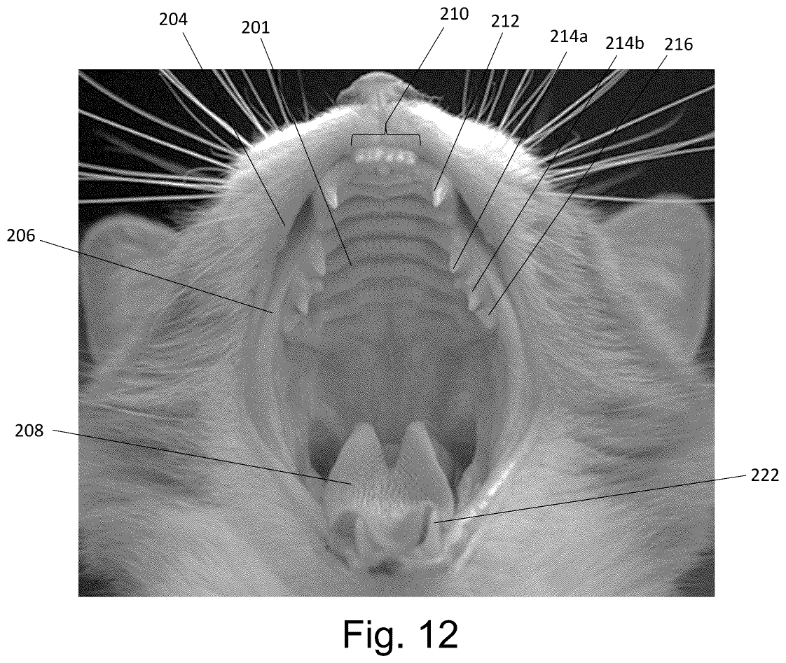

For example, reference is made to FIG. 12, showing the oral cavity of a cat. Reference is made to the oral cavity 201, the lip 204, the gums 206, the tongue 208, and the row of incisors 210, a canine 212, premolars 214a and 214b, and molar 216, of the upper jaw. A canine 222 of the lower jaw is shown but the premolars and molars of the lower jaw are not clearly visible and therefore are not label.

In embodiments, a device such as shown in FIGS. 1-7 can be used in a method that includes a step of contacting and then moving the pet's lip with the protuberance of the distal end of the device, and then contacting the pet's teeth and/or gums with the bristles of the cleaning head. The distal protuberance of the device to first contact the oral cavity of the pet and gently spreads the lip from the gum, thereby creating an access in an area between the pet's lips and gums for the cleaning head with the bristles.

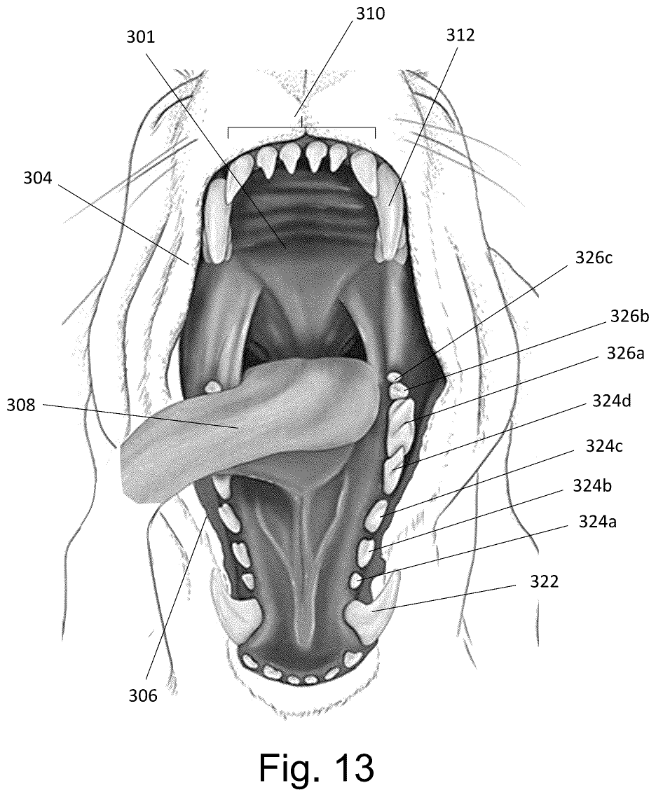

As another example, reference is made to FIG. 13, showing the oral cavity of a dog. Reference is made to the oral cavity 301, the lip 304, the gums 306, the tongue 308; a row of incisors 310 and a canine 312 of the upper jaw; and canine 322, premolars 324a, 324b, 324c, and 324d, and molars 326a, 326b, and 326c of the lower jaw.

In embodiments, a device such as shown in FIGS. 6-11 can be used in a method that includes a step of inserting the device into the oral cavity of the animal, such as a dog, and contacting gums or teeth of the subject with the bristles of the device. After the cleaning head of the device is withing the oral cavity of the pet, the method can include a step of contacting the back molars of a canine with the cleaning head, and then rotating the device, such as in a range of 90 to 180 degrees, to effect cleaning of the molars and gumline.

The invention also provides kits for providing oral hygiene to an animal. The kit can include device of the disclosure and an oral treatment composition, such as toothpaste or a composition that includes a medicament to treat gums, such as lidocaine, xylocaine, chlorhexidine, hyaluronic acid, corticosteroids, etc.

What is claimed is:

1. An oral hygiene device for use in the oral cavity of a pet, the device comprising a proximal portion comprising a handle to be held by a user, the handle optionally being along a central axis of the proximal portion, and a distal portion, the distal portion including bristles, the device including one or more of the following features:
the distal portion of the device including a cleaning head, the cleaning head including bristles and having distal and proximal ends, the distal end of the cleaning head including a distally-extending protuberance, optionally the protuberance configured to taper from wider to narrower as it extends distally, optionally the protuberance curves away from the cleaning head;
the distal portion of the device including a cleaning head, the cleaning head having distal and proximal ends, and including bristles having a bristle patten that is wider towards the proximal end as compared to the distal end,
the distal portion of the device including a cleaning head, the cleaning head having distal and proximal ends, and including bristles that are longer towards the proximal end as compared to the distal end,
the distal portion of the device including a cleaning head, the cleaning head including bristles, wherein the bristles are arranged on the cleaning head in the form of clusters of the bristles, wherein each cluster of bristles is spaced apart from other clusters of bristles on the cleaning head; optionally wherein bristles of each cluster are arranged in a staggered pattern on the cleaning head.
the distal portion including a cleaning head having bristles, the distal portion including a neck portion that is proximal to the cleaning head, the neck portion extending from the distal end of the proximal portion of the device, wherein part of the neck portion is angled away from the central axis of the proximal portion of the device, optionally the neck portion having a curved configuration; and/or
the distal portion of the device being detachable from the proximal portion of the device, optionally wherein the proximal portion of the device includes a protrusion on its distal end, and the distal portion of the device includes a recession on its proximal end, wherein the protrusion and recession can mate to lock the distal and proximal portions of the device together, optionally wherein locking occurs by twisting the proximal and distal portions relative to each other when the protrusion and recession are mated.

2. The device of claim 1 wherein the distal portion of the device comprises the distally-extending protuberance which tapers from wider to narrower as it extends distally, and is angled away from the cleaning head, and the protuberance has a tongue-like shape.

3. The device of claim 1 wherein the distal portion of the device comprises the distally-extending protuberance having surfaces comprising top surface, a bottom surface, a first curved side, and a second curved side, wherein the first curved side meets the second curved side at the distal end of the device and forms a rounded tip.

4. The device of claim 3 the first curved side of the protuberance extends from a first curved side wall of the cleaning head, and the second curved side of the protuberance extends from a second curved side wall of the cleaning head.

5. The device of claim 1 wherein the cleaning head has a top surface and bottom surface defining a cleaning head thickness, and the protuberance head has a top surface and bottom surface defining a protuberance thickness, and the cleaning head thickness is greater than the protuberance thickness.

6. The device of claim 1 wherein the distal portion of the device comprises the distally-extending protuberance having surfaces and none of the surfaces of the protuberance comprise bristles.

7. The device of claim 1 wherein the distal portion of the device including a cleaning head bristle patten that is wider towards the proximal end as compared to the distal end, and the cleaning head has a width at its narrowest part that is in the range of 50-90% of a width of the cleaning head at its widest part.

8. The device of claim 1 wherein the cleaning head has bristles that are longer towards the proximal end as compared to the distal end, which shortest bristles having a length in the range of 35-70%, or 40-60% of the length of the longest bristles.

9. The device of claim 1 wherein the neck portion is angled away from the central axis of the proximal portion (CA-PP) and the distal portion has a central axis (CA-DP), and the angle of lines CA-PP and CA-DP at their intersection is in the range of about 5° to about 40°, about 10° to about 35°, 12° to about 20°, or about 13° to about 19°.

10. The device of claim 1 wherein the neck, in a distal direction, has a diameter or a cross-sectional area gradually that becomes smaller in a distal direction, and also has a cross-sectional shape that changes in a distal direction, optionally wherein the cross-sectional shape changes from circular to oblong or oval, in a distal direction.

11. A method for providing oral hygiene to a pet that is an animal, comprising introducing the device of claim 1 into the oral cavity of the animal and contacting gums or teeth of the animal with at least a portion of device.

12. The method of claim 11 wherein the animal is a cat.

13. The method of claim 11 further comprising contacting and then moving a lip of the animal with the protuberance of the distal end of the device, and then contacting the pet's teeth and/or gums of the animal with the bristles of the cleaning head.

14. An oral hygiene device for use in the oral cavity of a pet, the device comprising a proximal portion that includes a handle to be held by a user, the handle optionally being along a central axis of the proximal portion, and a distal portion, the distal portion including bristles, the device including one or more of the following features:
the distal portion of the device including a cleaning head, the cleaning head having a cylindrical configuration and a circumferential surface, and bristles extending from circumferential surface, optionally the bristles arranged in a staggered pattern on the circumferential surface;
the distal portion of the device including a cleaning head, the cleaning head including bristles, wherein the bristles are arranged on the cleaning head in the form of clusters of the bristles, wherein each cluster of bristles is spaced apart from other clusters of bristles on the cleaning head; optionally wherein bristles of each cluster are arranged in a circular pattern on the cleaning head;
the distal portion including a cleaning head having bristles, the distal portion including a neck portion that is proximal to the cleaning head, the neck portion extending from the distal end of the proximal portion of the device, wherein part of the neck portion is angled away from the central axis of the proximal portion of the device, optionally the neck portion having a curved configuration; and/or
the distal portion of the device being detachable from the proximal portion of the device, optionally wherein the proximal portion of the device includes a protrusion on its distal end, and the distal portion of the device includes a recession on its proximal end, wherein the protrusion and recession can mate to lock the distal and proximal portions of the device together, optionally wherein locking occurs by twisting the proximal and distal portions relative to each other when the protrusion and recession are mated.

15. The device of claim 14, wherein the cleaning head comprises a first column of bristles extending from the proximal end to the distal end of the cleaning head, and a second column of bristles adjacent to the first column, the second column having one fewer bristle clusters than the first column, wherein the first and second columns repeat most or all of the circumference of the cleaning head.

16. A method for providing oral hygiene to a pet that is an animal, comprising introducing the device of claim 14 into the oral cavity of the animal and contacting gums or teeth of the animal with at least a portion of device, optionally wherein contacting comprises the back molars of a canine with the cleaning head, and then rotating the device, such as in a range of 90 to 180 degrees, to effect cleaning of the molars and gumline.

17. The method of claim 16 wherein the animal is a dog.

18. An oral hygiene system for use in the oral cavity of a pet, the device comprising a proximal portion configured as a handle, and a distal portion comprising a cleaning head with bristles, the distal portion being detachable from the proximal portion, wherein the proximal portion includes a protrusion on its distal end, and the distal portion includes a recession on its proximal end, wherein the protrusion and recession can mate to lock the distal and proximal portions together, wherein locking occurs by twisting the proximal and distal portions relative to each other when the protrusion and recession are mated.

19. The oral hygiene system of claim 18, wherein the system comprises at least two different distal portions, wherein the different distal portions are configured for use in different pets.

20. A kit for providing oral hygiene to an animal, comprising the device of claim 1 and an oral treatment composition.
